(19) United States
(12) Patent Application Publication
(10) Pub. No.: US 2026/0121251 A1
(43) Pub. Date: Apr. 30, 2026

(54) APPARATUS AND METHOD FOR MANUFACTURING SECONDARY BATTERY INCLUDING BENDING STRIP TERMINAL

(71) Applicant: SAMSUNG SDI CO., LTD., Yongin-si (KR)

(72) Inventors: Donghyun KIM, Yongin-si (KR); Yejin SEO, Yongin-si (KR); Eunjeong MOON, Yongin-si (KR)

(21) Appl. No.: 19/236,014

(22) Filed: Jun. 12, 2025

(30) Foreign Application Priority Data
Oct. 24, 2024 (KR) 10-2024-0146941

(51) Int. Cl. H01M 50/536; H01M 10/0583; H01M 50/103; H01M 50/105; H01M 50/533; H01M 50/538

(52) U.S. Cl. CPC H01M 50/536; H01M 10/0583; H01M 50/103; H01M 50/105; H01M 50/533; H01M 50/538

(57) ABSTRACT

An apparatus for manufacturing a secondary battery includes a welding unit configured to weld a strip terminal to electrode tabs of electrode plates in an electrode assembly, resulting in a welding portion, a lower jig configured to support a lower surface of the strip terminal excluding the welding portion, the lower jig being horizontal, and an upper jig configured to support an upper surface of the strip terminal including the welding portion, the upper jig being horizontal, wherein the strip terminal has a bending portion created by a downward force of the upper jig that pushes the strip terminal down and a rising force of the lower jig that pushes the strip terminal up, and while the upper jig and the lower jig support the strip terminal, the electrode tabs are bent by a movement force of the electrode assembly moving toward the upper jig and the lower jig.

### CROSS-REFERENCE TO RELATED APPLICATION

The present application claims priority to and the benefit of Korean Patent Application No. 10-2024-0146941, filed on Oct. 24, 2024, in the Korean Intellectual Property Office, the entire disclosure of which is incorporated herein by reference.

### BACKGROUND

### 1. Field

The present disclosure relates to an apparatus and method for manufacturing a secondary battery including bending a strip terminal.

### 2. Description of Related Art

Secondary batteries include primary batteries that are not rechargeable and secondary batteries that can be charged and discharged. Low-capacity secondary batteries are used in portable small electronic devices such as smartphones, feature phones, laptop computers, digital cameras, and camcorders, whereas large-capacity secondary batteries are widely used as power sources for driving motors in hybrid vehicles, electric vehicles, and the like as well as for power storage batteries. A secondary battery includes an electrode assembly formed of a positive electrode and a negative electrode, an exterior material such as a case, a can, or a pouch for accommodating the electrode assembly, and external terminals electrically connected to the electrode assembly.

The above information disclosed in this Background section is for enhancement of understanding of the background of the present disclosure, and therefore, it may contain information that does not constitute a related (or prior) art.

### SUMMARY

Embodiments include an apparatus for manufacturing a secondary battery, the apparatus including a welding unit configured to weld a strip terminal to electrode tabs on a plurality of electrode plates included in an electrode assembly, resulting in a welding portion, a lower jig configured to support a lower surface of the strip terminal excluding the welding portion, the lower jig being horizontal, and an upper jig configured to support an upper surface of the strip terminal including the welding portion, the upper jig being horizontal, wherein the strip terminal has a bending portion created by a downward force of the upper jig that pushes the strip terminal down and a rising force of the lower jig that pushes the strip terminal up, and while the upper jig and the lower jig support the strip terminal, the electrode tabs are bent by a movement force of the electrode assembly moving toward the upper jig and the lower jig.

The lower jig may bend the electrode tabs of the electrode assembly by a forward force that pushes the strip terminal with the bending portion toward the electrode assembly.

The upper jig may be separated from the strip terminal when the lower jig pushes the strip terminal with the bending portion toward the electrode assembly.

The upper jig may include an electrode tab support configured to support the electrode tabs of the electrode assembly.

A bending angle of the bending portion of the strip terminal may be 90° or less.

The lower jig may include a welding portion lower surface support configured to support a lower surface region of the welding portion of the strip terminal that is horizontal, and a strip terminal lower surface support configured to support a lower surface region of the strip terminal excluding the welding portion, and the upper jig includes a welding portion upper surface support configured to support an upper surface region of the welding portion of the strip terminal that is horizontal, and a strip terminal upper surface support configured to support an upper surface region of the strip terminal excluding the welding portion.

The bending portion of the strip terminal may be between a point where the welding portion lower surface support and the strip terminal lower surface support of the lower jig meet and a point where the welding portion upper surface support and the strip terminal upper surface support of the upper jig meet.

An internal angle between the strip terminal lower surface support and the welding portion lower surface support of the lower jig is 90° or less.

An internal angle between the strip terminal upper surface support and the welding portion upper surface support of the upper jig is 90° or less.

An internal angle between the strip terminal lower surface support and the welding portion lower surface support of the lower jig is a same internal angle as between the strip terminal upper surface support and the welding portion upper surface support of the upper jig.

Embodiments include a method of manufacturing a secondary battery, the method including providing an electrode assembly including a plurality of electrode plates having electrode tabs thereon, forming a welding portion by welding a strip terminal to the electrode tabs, placing the strip terminal horizontally, supporting a lower surface of the strip terminal excluding the welding portion, supporting an upper surface of the strip terminal including the welding portion, forming a bending portion of the strip terminal by pushing a portion of the strip terminal including the welding portion down, pushing a portion of the strip terminal excluding the welding portion up, and moving the electrode assembly toward the strip terminal to bend the electrode tabs, resulting in a bent strip terminal, further bending the electrode tabs by pushing the strip terminal toward the electrode assembly, resulting in bent electrode tabs, and accommodating the electrode assembly with the bent strip terminal and the bent electrode tabs inside an exterior material of the secondary battery.

Supporting the upper surface of the strip terminal may include supporting the electrode tabs of the electrode assembly from above.

A bending angle of the bending portion formed on the strip terminal may be 90° or less.

Accommodating the electrode assembly inside the exterior material may include accommodating the electrode assembly in a pouch of a pouch-type secondary battery.

Accommodating the electrode assembly inside the exterior material may include accommodating the electrode assembly in a can of a prismatic secondary battery.

Embodiments include a secondary battery, including an exterior material of the secondary battery, an electrode assembly accommodated in the exterior material, the electrode assembly including a plurality of electrode plates on which electrode tabs are formed, and a strip terminal including a welding portion welded to the electrode tabs and a bending portion bent within the exterior material, wherein a bending angle of the bending portion of the strip terminal is 90° or less.

The bending portion of the strip terminal may be located in a portion of the strip terminal excluding the welding portion.

The exterior material may be a pouch of a pouch-type secondary battery.

The exterior material may be a can of a prismatic secondary battery.

Aspects and features of the present disclosure include those described above and other aspects and features not specifically mentioned herein will be clearly understood by those of ordinary skill in the art from the description of the present disclosure below.

### BRIEF DESCRIPTION OF THE DRAWINGS

Features will become apparent to those of ordinary skill in the art by describing in detail exemplary embodiments with reference to the attached drawings, in which:

FIG. 1 is a schematic diagram illustrating an electrode assembly of a secondary battery;

FIG. 2 is a schematic diagram illustrating a pouch-type secondary battery to which the electrode assembly manufactured according to the present disclosure is applicable;

FIG. 3A is a diagram illustrating a bending structure of a strip terminal of the secondary battery according to some embodiments of the present disclosure;

FIG. 3B is a diagram illustrating a bending structure of a strip terminal of the secondary battery according to some other embodiments of the present disclosure;

FIG. 4 is a diagram for describing a strip terminal bending method;

FIGS. 5 to 8 are drawings for describing a strip terminal bending device and a bending process according to some embodiments of the present disclosure;

FIG. 9 is a diagram illustrating a strip terminal bending device according to some other embodiments of the present disclosure; and

FIG. 10 is a schematic diagram illustrating a prismatic secondary battery to which the electrode assembly manufactured according to the present disclosure is applicable.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her embodiments in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is understood that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or a and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

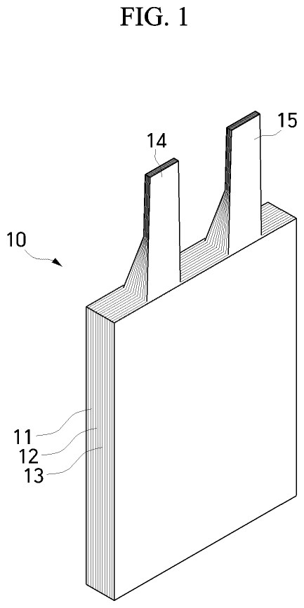

FIG. 1 is a schematic diagram illustrating an example of an electrode assembly of a secondary battery.

Referring to FIG. 1, an electrode assembly 10 may be formed by winding or stacking a stack of a first electrode plate 11, a separator 12, and a second electrode plate 13, each of the electrode plates being formed as thin plates or films. The electrode assembly 10 shown in FIG. 1 may be a stack type, but the shape of the electrode assembly 10 may be a wound type, or a Z-stack electrode assembly in which a positive electrode plate and a negative electrode plate are inserted into both sides (e.g., opposite sides) of a separator, which is then bent (or folded) into a Z-stack. In addition, one or more electrode assemblies may be arrayed and accommodated in a case or exterior material of a secondary battery, and the number of electrode assemblies in a case is not limited in the present disclosure. The first electrode plate 11 of the electrode assembly may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include first electrode tabs 14, which are regions to which the first electrode active material is not applied. The first electrode tabs 14 may be welded to each other and connected to an external first terminal.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include second electrode tabs 15, which are regions to which the second electrode active material is not applied. The second electrode tabs 15 may be welded to each other and connected to an external second terminal.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

In some embodiments, the electrode assembly 10 may be accommodated in an exterior material, such as a case, a can, a pouch, etc., along with an electrolyte. In a pouch-type secondary battery, an electrode assembly 10 may be accommodated in a pouch made of flexible material. In a cylindrical or prismatic secondary battery, an electrode assembly 10 may be accommodated in a cylindrical or prismatic metal can.

Hereinafter, suitable materials that may be used for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium-nickel oxide, a lithium-cobalt oxide, a lithium-manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but the substrate material may vary.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x≤2), a Si alloy, or a combination thereof.

The silicon-carbon composite may be a composite of silicon and amorphous carbon. According to an embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

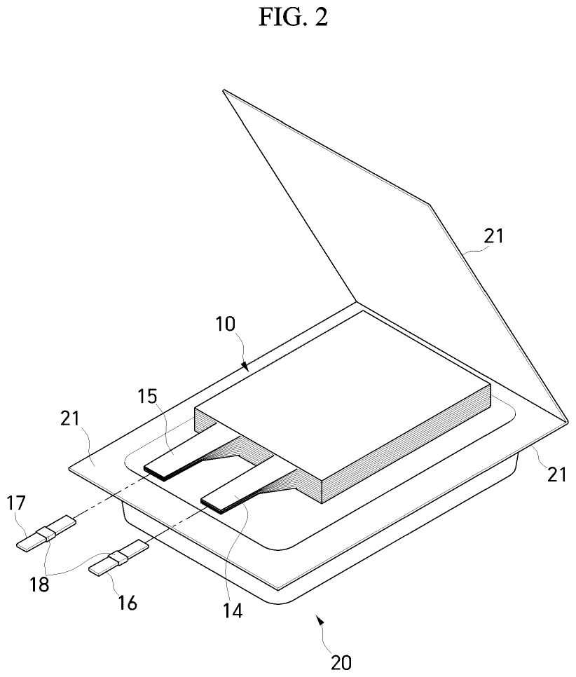

FIG. 2 schematically shows a pouch-type secondary battery according to embodiment(s) the present disclosure.

The pouch-type secondary battery according to the present embodiment may include an electrode assembly 10 and a pouch 20 for accommodating the electrode assembly 10.

As shown in FIG. 1, first electrode tabs 14 and second electrode tabs 15 of the electrode assembly 10 may be electrically connected to a first strip terminal 16 and a second strip terminal 17, respectively, which serve as terminals exposed to the outside. Tab films 18 for insulation with a pouch 20 may be bonded to the first strip terminal 16 and the second strip terminal 17.

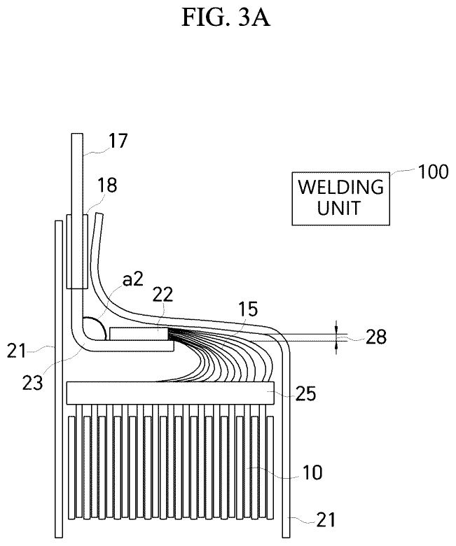

FIGS. 3A and 3B show a secondary battery to which a strip terminal bending structure according to some embodiments of the present disclosure is applied. These drawings are cross-sectional views illustrating a state in which the electrode tabs 15 and strip terminal 17 of the electrode assembly 10 in the pouch-type battery are bonded and bent to be accommodated inside an exterior material 21.

The shown secondary battery includes an exterior material 21 of the secondary battery, the electrode assembly 10 accommodated in the exterior material 21 and including a plurality of electrode plates on which electrode tabs 15 are formed, and the strip terminal 17 including a welding portion 22 formed by being welded to the electrode tabs 15 and a bending portion 23 bent inside the exterior material 21.

In some embodiments, a bending angle of the bending portion 23 of the strip terminal 17 may be an angle a2 of 90° or an angle a2′ of less than 90°.

In some embodiments, the bending portion 23 of the strip terminal 17 may be positioned in a region excluding the welding portion 22, but the position of the strip terminal 17 may vary.

In addition, the tab film 18 bonded to the strip terminal 17 may perform a sealing function at an outer boundary of the pouch 20 and may also perform an insulating function between the exterior material 21 and the strip terminal 17. A portion of the strip terminal 17 may be exposed to the outside.

The electrode tabs 15 and the strip terminal 17 may be bent to accommodate the electrode assembly 10 in an internal space of the pouch 20. The bending portion 23 of the strip terminal 17 may have a bending angle a2 of about 90° (see FIG. 3A) or may have a bending angle a2′ which is an acute angle that is smaller than 90° (see FIG. 3B). In this way, since the bending angle of the bending portion 23 of the strip terminal 17 becomes an angle that is less than or equal to 90°, upper spaces 28 and 28′ of the pouch 20 may be reduced so that space utilization of the battery can be increased.

In the embodiments of FIGS. 3A and 3B, the bending portion 23 of the strip terminal 17 may include a region excluding the welding portion 22. However, since the welding portion 22 may be included in the bending portion 23 of the strip terminal 17, when the strip terminal 17 is bent, the welding portion 22 may be bent together with the strip terminal 17.

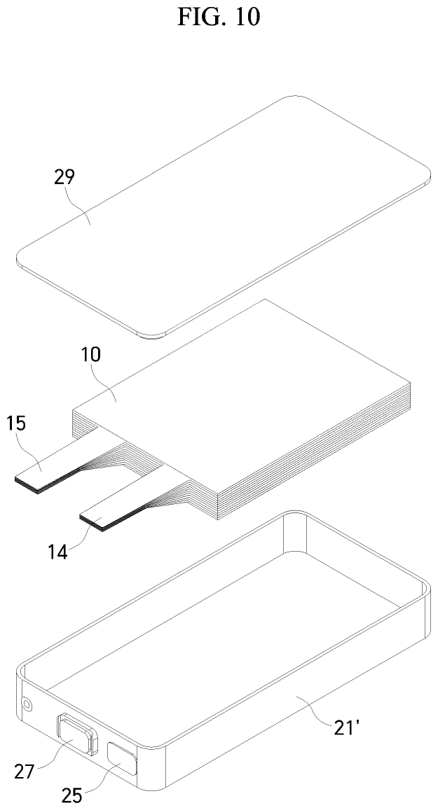

A component 25 in FIGS. 3A and 3B, which is not described, is an insulator for insulating the electrode assembly 10 from the electrode tabs 15 or the strip terminal 17. In addition, although the embodiments of FIGS. 3A and 3B relate to the bending structure of the strip terminal applied to a pouch of a pouch-type secondary battery, according to some embodiments, the bending structure of the strip terminal may also be applied to a can of a prismatic secondary battery (see FIG. 10).

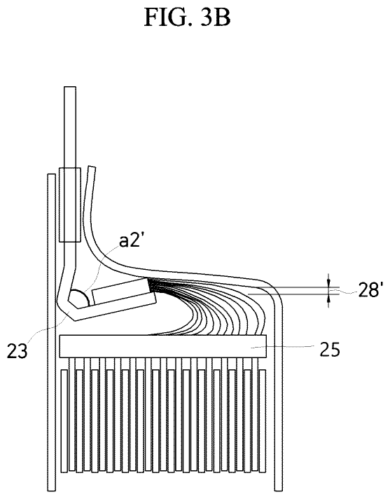

FIG. 4 is a schematic diagram for describing a comparative example of a method of bending the strip terminal 17. In a state in which the electrode assembly 10 and the strip terminal 17 are placed horizontally and a front guide 19a supports an upper portion of the electrode tabs 15, a lower pusher 19b pushes a lower surface of the strip terminal 17 up, and an upper pusher 19c pushes an upper surface of the strip terminal 17 down. When a rising force of the lower pusher 19b is greater than a downward force of the upper pusher 19c, bending of the strip terminal 17 begins as shown in FIG. 4. When the lower pusher 19b is advanced horizontally in a direction of the electrode assembly 10 in the state of FIG. 4, the strip terminal 17 and the electrode tabs 15 may be bent as shown in FIG. 3A or 3B.

In this way, the front guide 19a, the lower pusher 19b, and the upper pusher 19c are used as tools for bending the strip terminal 17 and the electrode tabs 15, and in addition, a mechanical mechanism and a control program for operations of the tools may be additionally included.

Reducing a process time and management locations in product manufacturing may be the ultimate goal of all processes. The above-described bending process of a strip terminal and an electrode tab during a secondary battery manufacturing process is no exception, and the present disclosure is devised to secure economic feasibility by reducing complexity of equipment required for the bending process and a process progress time.

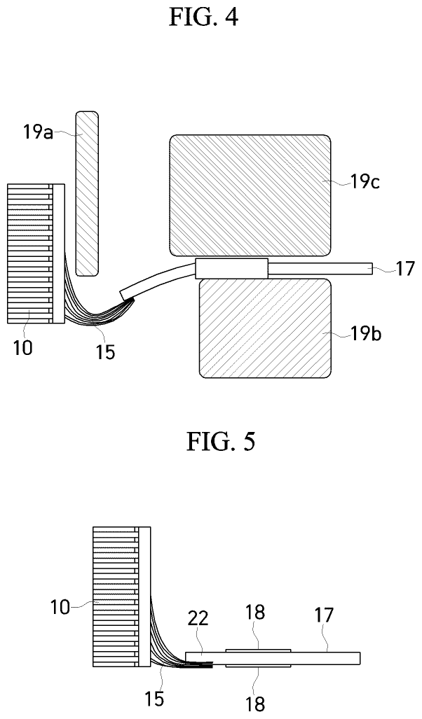

The apparatus and method for manufacturing a secondary battery according to some embodiments of the present disclosure will now be described. The following description focuses on the strip terminal bending process described above among the secondary battery manufacturing processes. FIGS. 5 to 8 are diagrams for describing a strip terminal bending device and method according to some embodiments.

Referring to FIGS. 3A and 3B described above and FIGS. 5 to 8 that will be described below, the apparatus for manufacturing a secondary battery according to some embodiments of the present disclosure includes a welding unit (e.g., welding unit 100 in FIG. 3A) configured to form the welding portion 22 by welding the strip terminal 17 to the electrode tabs 15 formed on a plurality of electrode plates included in the electrode assembly 10, a lower jig 40 configured to support a lower surface of the strip terminal 17 placed horizontally, and an upper jig 30 configured to support an upper surface of the strip terminal 17 placed horizontally.

Each component will be described in more detail.

The welding unit may be equipment for bonding the plurality of electrode tabs 15 by welding the strip terminal 17 to the electrode tabs 15 to form the welding portion 22 (see FIGS. 3A and 3B). The welding unit may include ultrasonic welding equipment or laser welding equipment, but the type of welding unit may vary.

FIG. 5 shows a side view of the electrode assembly 10 and the strip terminal 17, which are placed horizontally on a workbench, for bending the strip terminal 17 welded to the electrode tabs 15. The welding portion 22 of the electrode tabs 15 and the strip terminal 17 is shown. The tab films 18 may be attached to some regions of the strip terminal 17 excluding the welding portion 22. The tab films 18 may perform a sealing function at an outer boundary of the exterior material 21 (e.g., the pouch 20 of FIG. 2) as described with respect to FIGS. 3A and 3B and may also perform an insulating function between the exterior material and the strip terminal 17.

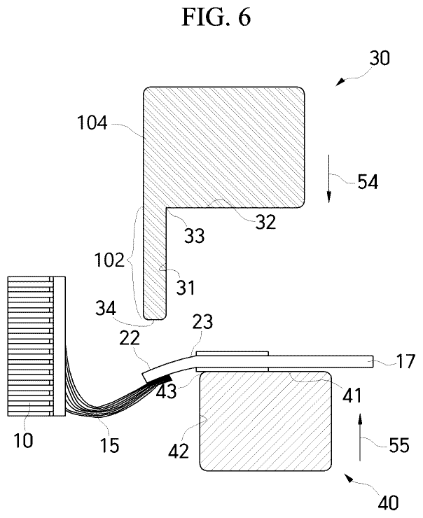

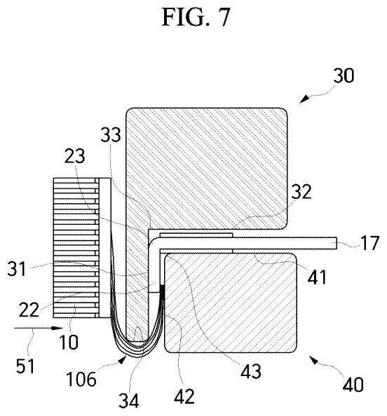

FIGS. 6 and 7 show the lower jig 40 configured to support the lower surface of the strip terminal 17 placed horizontally and the upper jig 30 configured to support the upper surface of the strip terminal 17.

In the bending environment configured in this manner, the strip terminal 17 is bent by a downward force 54 with which the upper jig 30 pushes the strip terminal 17 down and a rising force 55 with which the lower jig 40 pushes the strip terminal 17 up, thereby forming the bending portion 23 (see FIG. 6). In this way, in a state in which the upper jig 30 and the lower jig 40 support the strip terminal 17 from above and below, respectively, the electrode tabs 15 may be bent by a movement force 51 that moves the electrode assembly 10 toward the upper jig 30 and the lower jig 40 (see FIG. 7).

The formation of the bending portion 23 and the bending of the electrode tabs 15 will now be described in more detail.

First, referring to FIG. 6, the lower jig 40 may include a welding portion lower surface support 42 (e.g., a left side surface of the lower jig 40) configured to support a lower surface region of the welding portion 22 of the strip terminal 17 placed horizontally (e.g., when the electrode assembly 10 is moved closer to the upper jig 30 and the lower jig 40 in FIG. 7), and a strip terminal lower surface support 41 (e.g., a top surface of lower jig 40 in the orientation shown) configured to support a lower surface region excluding the welding portion 22 of the strip terminal 17. In FIG. 6, a point where the welding portion lower surface support 42 and the strip terminal lower surface support 41 meet (e.g., a common left upper edge of lower jig 40 in the orientation shown) forms a bending portion lower surface support 43 with an angle of about 90°. The bending portion lower surface support 43 may be positioned substantially on the lower surface of the bending portion 23 of the strip terminal 17 to allow the bending portion 23 to be bent at an angle of about 90°.

In addition, in FIG. 6, the upper jig 30 may include a welding portion upper surface support 31 (e.g., a right side surface of upper jig downward extension 102, in the orientation shown) configured to support an upper surface region between the bending portion 23 and the welding portion 22 of the strip terminal 17 placed horizontally, and a strip terminal upper surface support 32 (e.g., a bottom surface of the main portion 104 of upper jig 30, in the orientation shown) configured to support an upper surface region excluding the welding portion 22 of the strip terminal 17. In other words, the upper jig downward extension 102 extends downward toward the welding portion of strip terminal 17 (and lower jig 40). A length of the upper jig downward extension 102 may be chosen such that as the electrode assembly 10 is moved toward the upper jig 30 and the lower jig 40, the electrode tab support 34 creates the bending portion 106 of electrode tabs 15. In the upper jig 30, a point where the welding portion upper surface support 31 and the strip terminal upper surface support 32 meet forms a bending portion upper surface support 33 (e.g., a common left lower edge of the main portion 104 of the upper jig 30) with an angle of about 90°. The bending portion upper surface support 33 is positioned substantially on the upper surface of the bending portion 23 of the strip terminal 17 (see FIG. 7), and the strip terminal 17 is inserted between the bending portion upper surface support 33 and the bending portion lower surface support 43 of the lower jig 40 to allow the bending portion 23 to be bent at an angle of about 90°. In some embodiments, an inner angle of the point where the strip terminal lower surface support 41 and the welding portion lower surface support 42 of the lower jig 40 meet (i.e., the bending portion lower surface support 43) may be the same as an inner angle of the point where the strip terminal upper surface support 32 and the welding portion upper surface support 31 of the upper jig 30 meet (i.e., the bending portion upper surface support 33).

The upper jig 30 may also include an electrode tab support 34 configured to support the electrode tabs 15 from above. As shown in FIG. 7, the electrode tab support 34 may be positioned lower than the strip terminal upper surface support 32 so that a bending portion 106 of the electrode tabs 15 may be formed lower than the bending portion 22 of the strip terminal 17. As shown in FIG. 6, the electrode tab support 34 may push a region between the electrode tabs 15 and the welding portion 22 down from above at the beginning of the bending process, and as shown in FIG. 7, after the strip terminal 17 is bent, the electrode tab support 34 may push the electrode tabs 15 down from above to support the electrode tabs 15 (e.g., and to bend the electrode tabs 15).

With the upper jig 30 and the lower jig 40 configured in this manner, the bending of the strip terminal 17 may start as shown in FIG. 6. That is, the upper jig 30 is moved down, the electrode tab support 34 pushes the region between the welding portion 22 of the strip terminal 17 and the electrode tabs 15 down from above, and the strip terminal lower surface support 41 of the lower jig 40 pushes the strip terminal 17 up from below so that the bending starts. Thereafter, the upper jig 30 is moved further down (via downward force 54) and the lower jig 40 is moved further up (via rising force 55), and thus the strip terminal 17 is inserted between a substantially L-shaped lower outer surface formed by the welding portion upper surface support 31, the strip terminal upper surface support 32, and the bending portion upper surface support 33 of the upper jig 30 and a substantially L-shaped upper outer surface formed by the welding portion lower surface support 42, the strip terminal lower surface support 41, and the bending portion lower surface support 43 of the lower jig 40 so that the bending portion 23 is bent at an angle of about 90° as shown in FIG. 7 to form the bending portion 23. In this case, while the electrode tab support 34 of the upper jig 30 supports the electrode tabs 15, a movement force 51 with which the electrode assembly 10 is moved horizontally toward the upper jig 30 and the lower jig 40 is added so that the electrode tabs 15 may be bent.

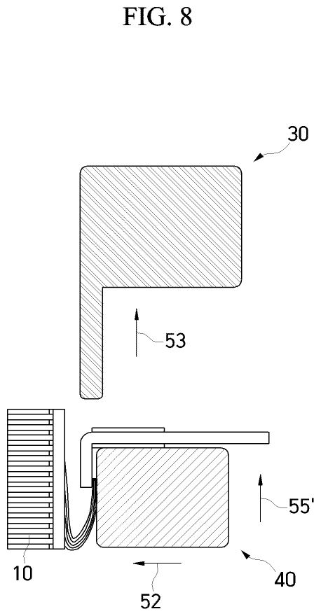

FIG. 8 shows a process of additionally bending the bent electrode tabs 15 to move the bent electrode tabs 15 close to the electrode assembly 10. While the strip terminal 17 is bent between the upper jig 30 and the lower jig 40 and the electrode tabs 15 are bent by the movement force 51 of the electrode assembly 10 as shown in FIG. 7, the lower jig 40 may be moved up by an additional rising force 55′ to move up the strip terminal 17 on which the bending portion 23 is already formed, and simultaneously, the electrode tabs 15 of the electrode assembly 10 may be additionally bent by the forward force 52 that pushes the welding portion 22 toward the electrode assembly 10. In this case, the upper jig 30 may be moved up (arrow 53) to separate from the strip terminal 17 so as not to interfere with the lower jig 40 pushing the welding portion 22 of the strip terminal 17 toward the electrode assembly 10.

As described above, the bending angle of the bending portion 23 of the strip terminal 17 may be an acute angle of 90° or less. To this end, the internal angle formed by the strip terminal lower surface support 41 and the welding portion lower surface support 42 of the lower jig 40 may be designed as an angle of 90° or less, and the internal angle formed by the strip terminal upper surface support 32 and the welding portion upper surface support 31 of the upper jig 30 may be designed as an angle of 90° or less.

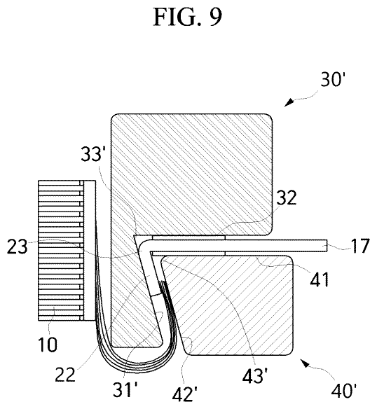

FIG. 9 shows an embodiment of an upper jig 30′ and a lower jig 40′ forming a bending portion 23 of a strip terminal 17 to have an acute angle.

Referring to FIG. 9, each of an inner angle of a bending portion upper surface support 33′ of the upper jig 30 and an inner angle of the bending portion lower surface support 43′ of the lower jig 40 is designed as an acute angle of less than 90° (e.g., 60°). In this way, since the bending angle of the strip terminal 17 becomes 60° that is smaller than 90°, the secondary battery providing the same effect as described in FIGS. 3A and 3B can be provided.

A method of manufacturing a secondary battery using the apparatus for manufacturing a secondary battery described above will now be briefly described. The method of manufacturing a secondary battery according to some embodiments of the present disclosure includes providing an electrode assembly including a plurality of electrode plates on which electrode tabs 15 are formed, forming a welding portion 22 by welding a strip terminal 17 to the electrode tabs formed on the plurality of electrode plates of the electrode assembly, supporting a lower surface of the strip terminal 17 placed horizontally excluding the welding portion 22, supporting an upper surface of the strip terminal 17 placed horizontally including the welding portion 22, forming a bending portion 23 of the strip terminal 17 by pushing a portion including the welding portion 22 of the strip terminal 17 down and pushing a portion excluding the welding portion 22 up, and moving the electrode assembly 10 toward the strip terminal 17 to bend the electrode tabs 15, further bending the electrode tabs 15 of the electrode assembly 10 by pushing the strip terminal 17 on which the bending portion 23 is formed toward the electrode assembly 10, and accommodating the electrode assembly with the bent strip terminal and the bent electrode tabs into the electrode assembly.

In some embodiments, the supporting of the upper surface of the strip terminal 17 may include supporting the electrode tabs 15 of the electrode assembly 10 from above.

In some embodiments, the bending angle of the bending portion 23 formed on the strip terminal 17 may be 90° or less.

In some embodiments, accommodating the electrode assembly 10 in which the strip terminal 17 and the electrode tabs 15 are bent into an exterior material may be performed using an exterior material accommodating method. For example, in the case of a pouch-type secondary battery, as shown in FIG. 3, the tab film 18 of the strip terminal 17 may be sealed at an upper boundary of the pouch 20, and a portion of the strip terminal 17 may be exposed to the outside. As another example, in the case of a prismatic secondary battery, the electrode assembly may be inserted into a can, such as aluminum or stainless use steel (SUS), and the strip terminal may be welded to an external terminal (see FIG. 10).

The secondary battery and the apparatus and method for manufacturing the same according to the above-described embodiments of the present disclosure may be applied to types of secondary batteries other than the pouch-type batteries exemplified above (e.g., prismatic secondary batteries).

For example, a prismatic secondary battery shown in FIG. 10 has a structure in which a wide lateral surface of a can 21′ that is an exterior material of a battery is open, the electrode assembly 10 is inserted into the opening, and a cover 29 covers the opening. A first strip terminal and a second strip terminal electrically connected to a first terminal 27 and a second terminal 25, which are exposed to the outside of the can 21′, may be connected to the first electrode tabs 14 and the second electrode tabs 15 of the electrode assembly 10 inside the outer can 21′ by welding, and the first strip terminal and the second strip terminal may be bent by the bending method of the present disclosure described above.

An electrical connection between the electrode assembly and the external terminals may be made by welding electrode tabs formed on the electrode assembly to strip terminals. When the electrode assembly is assembled with the exterior material of the battery (a can or pouch), there are cases in which strip terminals are welded to the electrode tabs formed on electrode plates and the strip terminals and the electrode tabs are bent.

Tools such as a front guide, a lower pusher, and an upper pusher are used to bend the strip terminals and the electrode tabs, and a mechanical mechanism and a control program may be additionally required for operating the tools.

According to the present disclosure, by reducing complexity of tools and a process progress time required for a process of bending a strip terminal and electrode tabs during a secondary battery manufacturing process, a mechanical mechanism and a control program can be simplified, thereby reducing costs of manufacturing secondary batteries.

Reducing a process time and management locations in product manufacturing may be the ultimate goal of all processes. The above-described bending process of a strip terminal and an electrode tab during a secondary battery manufacturing process is no exception, and the present disclosure is devised to solve a problem of securing economic feasibility by reducing the number of pieces of equipment required for the bending process and a process progress time.

Although the present disclosure has been described above with respect to embodiments thereof, the present disclosure is not limited thereto. Various modifications and variations can be made thereto by those skilled in the art within the spirit of the present disclosure as defined by the appended claims and their equivalents.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An apparatus for manufacturing a secondary battery, the apparatus comprising:
a welding unit configured to weld a strip terminal to electrode tabs on a plurality of electrode plates included in an electrode assembly, resulting in a welding portion;
a lower jig configured to support a lower surface of the strip terminal excluding the welding portion, the lower jig being horizontal; and
an upper jig configured to support an upper surface of the strip terminal including the welding portion, the upper jig being horizontal,
wherein the strip terminal has a bending portion created by a downward force of the upper jig that pushes the strip terminal down and a rising force of the lower jig that pushes the strip terminal up, and while the upper jig and the lower jig support the strip terminal, the electrode tabs are bent by a movement force of the electrode assembly moving toward the upper jig and the lower jig.

2. The apparatus as claimed in claim 1, wherein the lower jig bends the electrode tabs of the electrode assembly by a forward force that pushes the strip terminal with the bending portion toward the electrode assembly.

3. The apparatus as claimed in claim 2, wherein the upper jig is separated from the strip terminal when the lower jig pushes the strip terminal with the bending portion toward the electrode assembly.

4. The apparatus as claimed in claim 1, wherein the upper jig comprises an electrode tab support configured to support the electrode tabs of the electrode assembly.

5. The apparatus as claimed in claim 1, wherein a bending angle of the bending portion of the strip terminal is 90° or less.

6. The apparatus as claimed in claim 1, wherein:
the lower jig comprises a welding portion lower surface support configured to support a lower surface region of the welding portion of the strip terminal that is horizontal, and a strip terminal lower surface support configured to support a lower surface region of the strip terminal excluding the welding portion; and
the upper jig comprises a welding portion upper surface support configured to support an upper surface region of the welding portion of the strip terminal that is horizontal, and a strip terminal upper surface support configured to support an upper surface region of the strip terminal excluding the welding portion.

7. The apparatus as claimed in claim 6, wherein the bending portion of the strip terminal is between a point where the welding portion lower surface support and the strip terminal lower surface support of the lower jig meet and a point where the welding portion upper surface support and the strip terminal upper surface support of the upper jig meet.

8. The apparatus as claimed in claim 6, wherein an internal angle between the strip terminal lower surface support and the welding portion lower surface support of the lower jig is 90° or less.

9. The apparatus as claimed in claim 6, wherein an internal angle between the strip terminal upper surface support and the welding portion upper surface support of the upper jig is 90° or less.

10. The apparatus as claimed in claim 6, wherein an internal angle between the strip terminal lower surface support and the welding portion lower surface support of the lower jig is a same internal angle as an internal angle between the strip terminal upper surface support and the welding portion upper surface support of the upper jig.

11. A method of manufacturing a secondary battery, the method comprising:
providing an electrode assembly including a plurality of electrode plates having electrode tabs thereon;
forming a welding portion by welding a strip terminal to the electrode tabs;
placing the strip terminal horizontally;
supporting a lower surface of the strip terminal excluding the welding portion;
supporting an upper surface of the strip terminal including the welding portion;
forming a bending portion of the strip terminal by pushing a portion of the strip terminal including the welding portion down, pushing a portion of the strip terminal excluding the welding portion up, and moving the electrode assembly toward the strip terminal to bend the electrode tabs, resulting in a bent strip terminal;
further bending the electrode tabs by pushing the strip terminal toward the electrode assembly, resulting in bent electrode tabs; and
accommodating the electrode assembly with the bent strip terminal and the bent electrode tabs inside an exterior material of the secondary battery.

12. The method as claimed in claim 11, wherein supporting the upper surface of the strip terminal comprises supporting the electrode tabs of the electrode assembly from above.

13. The method as claimed in claim 11, wherein a bending angle of the bending portion formed on the strip terminal is 90° or less.

14. The method as claimed in claim 11, wherein accommodating the electrode assembly inside the exterior material comprises accommodating the electrode assembly in a pouch of a pouch-type secondary battery.

15. The method as claimed in claim 11, wherein accommodating the electrode assembly inside the exterior material comprises accommodating the electrode assembly in a can of a prismatic secondary battery.

16. A secondary battery, comprising:
an exterior material;
an electrode assembly accommodated in the exterior material, the electrode assembly including a plurality of electrode plates on which are electrode tabs; and
a strip terminal including a welding portion welded to the electrode tabs and a bending portion bent within the exterior material,
wherein a bending angle of the bending portion of the strip terminal excluding the welding portion is 90° or less.

17. The secondary battery as claimed in claim 16, wherein the bending portion of the strip terminal is located adjacent to the welding portion.

18. The secondary battery as claimed in claim 16, wherein the exterior material is a pouch of a pouch-type secondary battery.

19. The secondary battery as claimed in claim 16, wherein the exterior material is a can of a prismatic secondary battery.
